(19) United States
(12) Patent Application Publication
(10) Pub. No.: US 2010/0140844 A1
(43) Pub. Date: Jun. 10, 2010

(54) METHOD AND APPARATUS FOR MANUFACTURING PRODUCTS

(75) Inventor: Hendricus Antonius Hoogland, Wormer (NL)

Correspondence Address: HOFFMANN & BARON, LLP, 6900 JERICHO TURNPIKE, SYOSSET, NY, 11791, US

(73) Assignee: ECIM TECHNOLOGIES B.V., Ijssel (NL)

(21) Appl. No.: 12/375,307

(22) PCT Filed: Jul. 30, 2007
(86) PCT No.: PCT/NL2007/050379

§ 371 Date: Feb. 2, 2010

(30) Foreign Application Priority Data
Jul. 28, 2006 (NL) 1032248

(51) Int. Cl. B29C 45/56; B29C 45/37

(52) U.S. Cl. 264/328.7; 425/577

(57) ABSTRACT

A method for manufacturing products (2) using a mold having at least one mold (1) cavity (6) with at least one injection point (ISA) and at least one flow path (V) which extends from said at least one injection point in the direction of a longitudinal edge-forming part of the mold cavity situated at a relatively large distance from said at least one injection point, in which longitudinal edge-forming part a longitudinal edge of said product is formed, which mold cavity has at least one first movable wall (14) part which is situated in and/or near said longitudinal edge-forming part, wherein said first movable wall part has been or is brought in a first position, wherein a mass is introduced under pressure into the mold cavity, and fills the mold cavity at least in and/or near said longitudinal edge-forming part, after which said at least one first movable wall part is moved in the direction of said opposite first wall part.

This invention relates to a method for manufacturing products.

Injection molding is a known method that is used for manufacturing products, especially, though not exclusively so, from plastic. A mass in liquid, at least molten, form is then introduced under pressure into a mold cavity and allowed to solidify therein. A disadvantage of such a method is that relatively high pressures need to be used to fill the entire mold cavity, so that the properties of the starting material are adversely affected, in particular when plastic is used. Moreover, the maximum attainable flow path in the case of relatively thin products is relatively short, so that it is difficult, if possible at all, to manufacture large, thin-walled products by injection molding, especially from high-melt plastics.

It has previously been proposed to effect injection molding in a mold cavity with a movable wall part. In that way, initially the flow path can be enlarged in cross section, so that the mass can pass more easily. When the mold cavity is filled wholly or partly, the movable wall part is then moved forward, in the direction of an opposite wall part, so that the flow path is adjusted to the desired cross section. In this way, the required pressures for injecting the mass and hence also the required closing pressure for keeping the mold closed, can be lowered. Such a method is for instance described in WO 2004/024416. This known method, however, especially with relatively viscous masses such as low-melt plastics and with long, thin flow paths, can still lead to a deterioration of the quality of the material and undesirably high pressures. Moreover, it is difficult to keep such products form-retaining during cooling in particular. For instance edges of the products or whole surfaces or parts thereof may be subject to deformation, such as warp.

An object of the invention is to provide a method for manufacturing products of a high quality.

Another object of the invention is to provide a method for manufacturing in particular plastic products with low internal stresses.

A further object of the invention is to provide a method for manufacturing products with relatively thin walls that allows the use of relatively low injection pressures and where relatively low closing pressures suffice, in proportion to conventional injection molding.

At least one of these objects or other objects is or are achieved with a method according to the invention.

In a first aspect, a method according to the invention is characterized in that a mold is used having at least one mold cavity, which mold cavity has at least one movable wall part. A mass is introduced under pressure into the mold cavity, such that it is moved between the at least one movable wall part and an opposite mold part. The at least one movable wall part preferably has a frontal surface facing the opposite mold part that is relatively small in proportion to the whole surface, in particular the frontal surface of the respective opposite mold part, and is situated relatively closely to a longitudinal edge-forming part of the mold part. During molding of a product, when plastic is situated between the movable wall part and the opposite mold part, the movable wall part is moved relatively fast in the direction of the opposite mold part, so that a part of the plastic is compressed, at least is placed under pressure by the movable wall part.

In this description, longitudinal edge (-forming part) of a mold cavity or product should herein at least be understood to mean a portion of the mold cavity that forms a free edge of a product to be formed, such as en end edge of a surface, or the above-mentioned free longitudinal edge, respectively. Also, a longitudinal edge (-forming part) may be understood to mean an edge of a portion of a mold cavity which defines an edge of a surface of a product to be formed, or such an edge in the respective product, respectively. A non-limiting example thereof is, for instance, a rib of a product such as a transition from a bottom to a sidewall or from a sidewall to a sidewall in a product in the form of a tray, crate or like container, or a mold cavity therefor.

Preferably, the movable wall part is moved after the mold cavity has been filled with plastic, at least the plastic needed for a product or series of products to be formed has been introduced into the mold.

Without wishing to be bound by any theory, it seems that the movement of the at least one movable wall part as mentioned has as a result that a part of the plastic is pressurized, thereby compensating for, for instance, shrinkage of the cooling plastic. Usually, in plastic injection molding, for some time after injection of the plastic, holding pressure needs to be applied, via the or an injection opening, in order to compensate for shrinkage in the plastic. Such holding pressure is to be transmitted through the whole volume of plastic, which means that the pressure needs to be relatively high and moreover may lead to unwanted pressure effects in the mold cavity, for instance because the pressure is not uniformly distributed or because a part of the plastic has already frozen before the mold cavity is completely filled. Further, applying such holding pressure requires some time, as a result of which the cycle time of an injection molding cycle is adversely affected. Especially with longitudinal edges of a product and/or with relatively large surfaces, in proportion to the thickness thereof, this may lead to unwanted deformation, incomplete mold cavity filling and other disadvantages. By using a method according to the invention, a product can be manufactured for which less or even no holding pressure is necessary. In this way, the product quality can be improved, the cycle time can be shortened and moreover deformations are prevented.

In a further embodiment, the above-mentioned opposite wall part and the movable wall part each have a frontal surface, viewed in the direction of movement of the respective at least one movable wall part, while the frontal surface or joint frontal surface of the or the joint movable wall parts is smaller than that of the opposite wall part, in particular at most approximately 50% of the frontal surface of the opposite wall part, in particular at most 25% of that frontal surface. As a result, a relatively small force can suffice for the desired movement, so that for instance the drive means can be made of light design and moreover the response time thereof can be kept low.

In a further aspect of the invention, a method according to the invention is characterized in that plastic is brought between at least one movable wall part and an opposite wall part, with the movable wall part having been or being brought in a first position. Next, the movable wall part is moved during a first phase with a first average speed over a first distance in the direction of the opposite wall part and then in a second phase with a second average speed over a second distance in the direction of the opposite wall part. In the second phase, the acceleration and/or average speed of the at least one movable wall part will preferably be chosen such that adiabatic heat development occurs in the plastic.

In such a method, the mass, during introduction into the mold cavity, is at least partly supported in its movement by the movement of the at least one movable wall part. As a result, the pressure needed for introducing the plastic is lowered, while the stresses in the plastic are thereby reduced, both compared with the conventional injection molding methods and compared with injection compression molding.

Surprisingly, it has been found that with a method according to the invention, when using plastics, the quality of the plastic after the molding of a product can be virtually equal to that of the plastic such as it is introduced into the mold. For instance the modulus of elasticity will substantially not diminish. As a result, the strength of the plastic, at least of the product that is formed therefrom, will be advantageously affected. This means that, starting from the same plastic, with a method according to the invention a product can be manufactured that is stronger than a same product manufactured from the same plastic using a conventional injection molding technique, or that for injection molding a product with conventional injection molding technique a higher-grade plastic needs to be chosen as starting material to arrive at the same properties as of a same product manufactured with a method according to the invention.

In a still further aspect, a method according to the invention is characterized in that in the first phase the movable wall part is moved such that mass included between the movable wall part and the opposite wall part is moved in at least one direction approximately parallel to a surface of the movable wall part facing the mass, substantially without compression in a direction at right angles to that surface, while in the second phase the plastic is compressed between the movable wall part and the opposite part, such that adiabatic heat development occurs therein, so that the viscosity of the respective mass is lowered.

With such a method, a mold cavity can be filled with even less pressure and less stress in the mass, also when passages are relatively long and/or narrow.

The invention furthermore relates to an apparatus for forming products, in particular plastic products.

In a first aspect, an apparatus according to the invention is characterized by a mold having at least one mold cavity which has at least one first movable wall part, wherein drive means are provided for driving the at least one first movable wall part, which mold cavity comprises at least one injection point and defines at least one flow path between the injection point and a longitudinal edge of the mold cavity, at a distance from the injection point, wherein the at least one first movable wall part is situated closer to the longitudinal edge than to the injection point, measured along the flow path.

Such a mold can afford various advantages over known molds for use in injection molding technique. For instance, products can be formed more simply and better, for instance without holding pressure, tauter, with less loss of material quality, in a shorter cycle time and/or with less pressure. Moreover, relatively small and simple attachments can be used, such as a small press, or even no press, a relatively small and light injection device for the plastic, simple devices for placing inserts such as labels and taking out the products and the like.

In a second aspect, an apparatus according to the invention is characterized by a mold having at least one mold cavity and at least one injection point, which mold cavity has at least one primary movable wall part, with primary drive means being provided for driving the at least one primary movable wall part, which primary drive means are arranged for moving the at least one primary movable wall part in a first phase with a first average speed and moving the primary movable wall part in a second phase over a second distance with a second average speed, the second average speed being higher than the first and being sufficient to generate adiabatic heat development in a mass between the at least one primary movable wall part and an opposite wall part.

Such a mold can afford comparable advantages to a mold described with regard to the above-mentioned first aspect. Moreover, the mass in the mold can be distributed still better than in conventional injection molding, while such molds enable simpler manufacture of products having relatively thin, large surfaces, long flow paths with narrow passages, complex shapes and flow paths and the like. Here, the advantage seems to exist that as long as the plastic is still relatively liquid, the plastic can be moved relatively simply by the or each movable wall part, while thereupon, preferably at the end of the injection step, a part of the plastic is moved further by the or each movable wall part, in order to fill the mold cavity completely. Owing to the speed of the or each movable wall part, the temperature in the plastic will then increase, adjacent the movable wall parts, so that the viscosity is lowered and the plastic is going to flow more easily. It is then preferred that the movable wall part is held in the second position for some time, under pressure, so that shrinkage in the plastic during cooling is compensated, without holding pressure needing to be applied.

In the described embodiments of an apparatus according to the invention, it is preferred that a second or further movable wall part is provided near the or an injection point, in particular between the injection point and the movable wall part, viewed along the respective flow path. This second or further movable wall part is provided with drive means and control means, by which it can be moved between a first position, relatively far from the opposite wall part of the mold cavity, and a second position, closer thereto, which movement is commenced during or directly after the introduction of the mass into the mold cavity, between the second or further movable wall part and the opposite wall part. The mass is then pushed away for a part by the movable wall part, in the direction of the earlier mentioned movable wall part near the longitudinal edge and preferably to a point between that wall part and an opposite wall part. In particular, it is then advantageous if the movement of the second or further wall part has been completed before the or a, in particular each, moving wall part near the longitudinal edge is set into motion. The first-mentioned movement is then preferably carried out so fast that adiabatic heat development occurs between the second or further movable wall part and the opposite wall part, so that the viscosity of the mass therebetween is lowered and hence that mass is going to flow better, without additional heat needing to be supplied from outside. The mass can then be introduced into the mold at a lower temperature, so that the cycle time is further reduced. By providing this at least one further or second movable wall part near the injection point, the mass can be readily moved directly after or during the injection.

In clarification of the invention, exemplary embodiments of methods and apparatuses according to the invention will be elucidated in more detail with reference to the drawing. In the drawing:

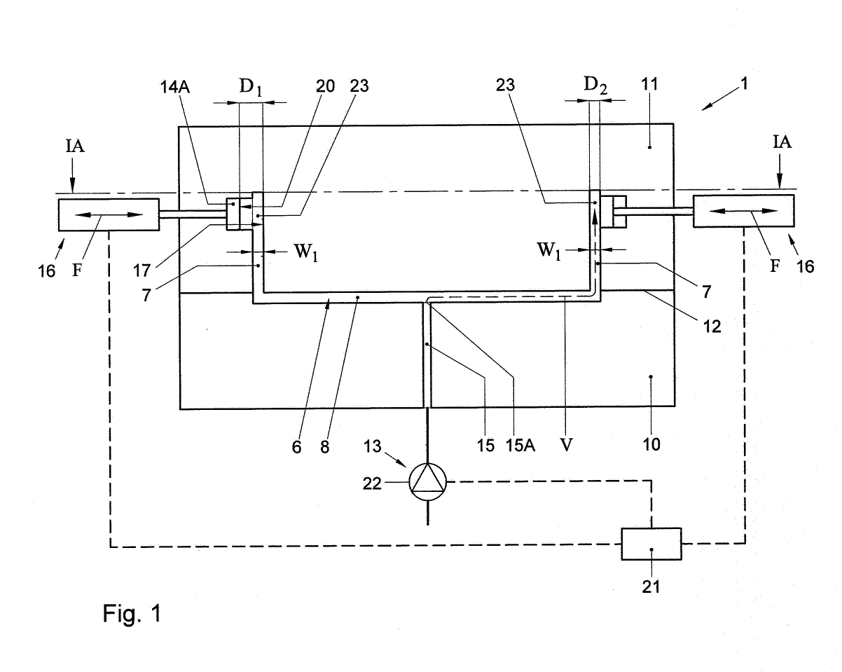

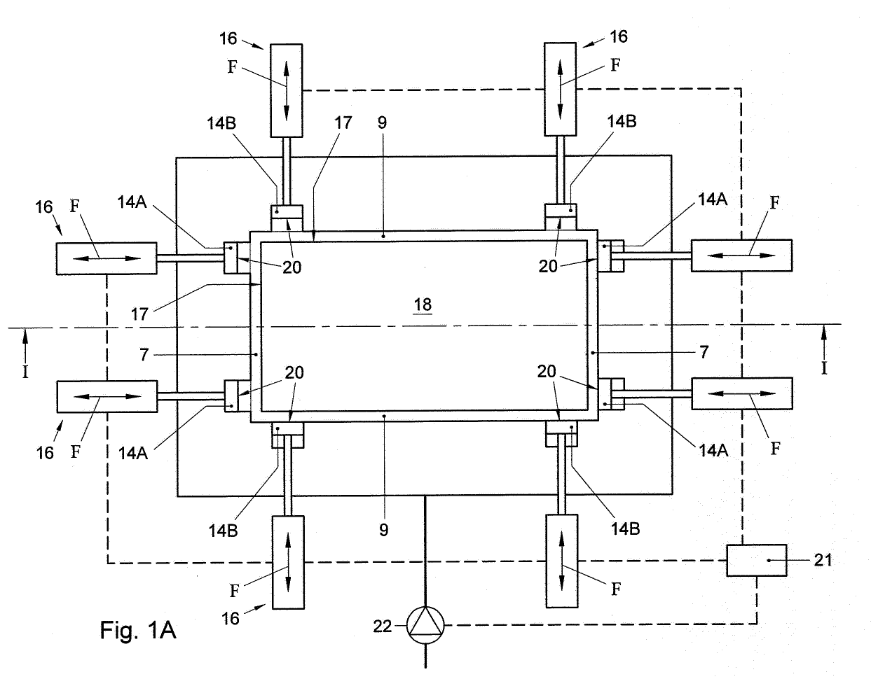

FIG. 1 schematically shows in sectional front view a mold according to the invention, in a first embodiment, with a first movable wall part in a first position (left) and in a second position (right);

FIG. 1A shows the mold according to FIG. 1, in sectional top plan view, with first movable wall parts in a first position (left and top) and in a second position (right and bottom);

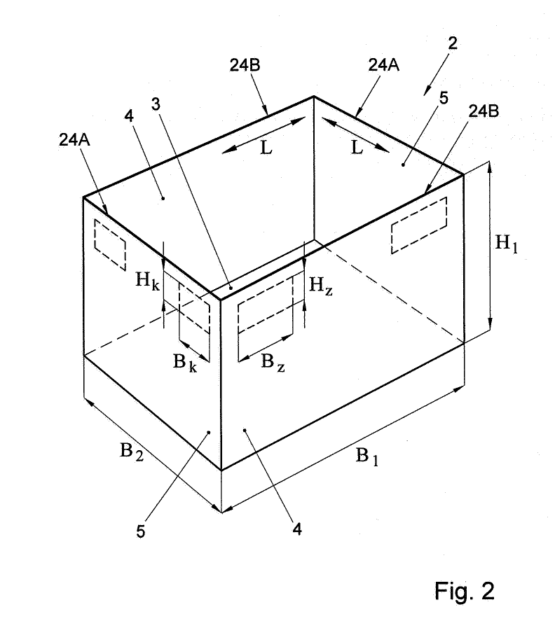

FIG. 2 schematically shows in perspective view a product formed in a mold according to FIG. 1, with the position of two first movable wall parts drawn in;

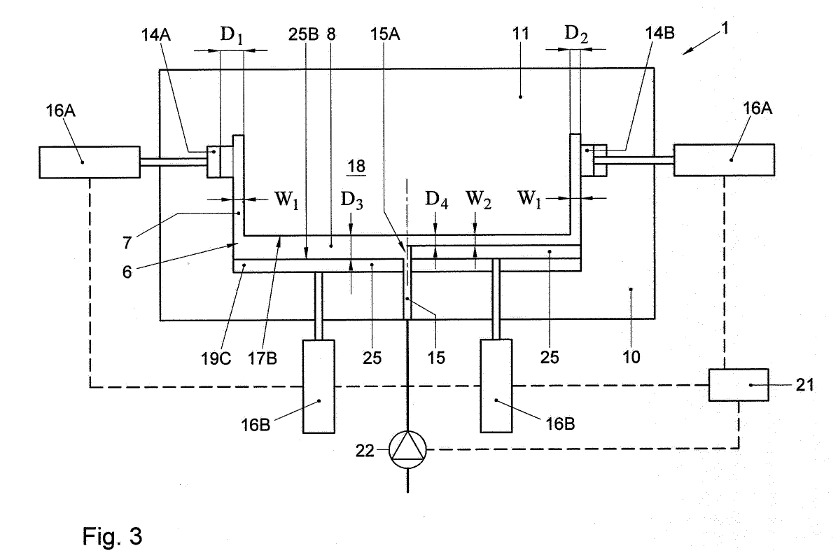

FIG. 3 schematically shows in sectional front view a mold according to the invention, in a second embodiment, with a first movable wall part in a first position (left) and in a second position (right) and with a second movable wall part in a bottom-forming part of the mold cavity, in a first position (broken lines) and a second position (full lines);

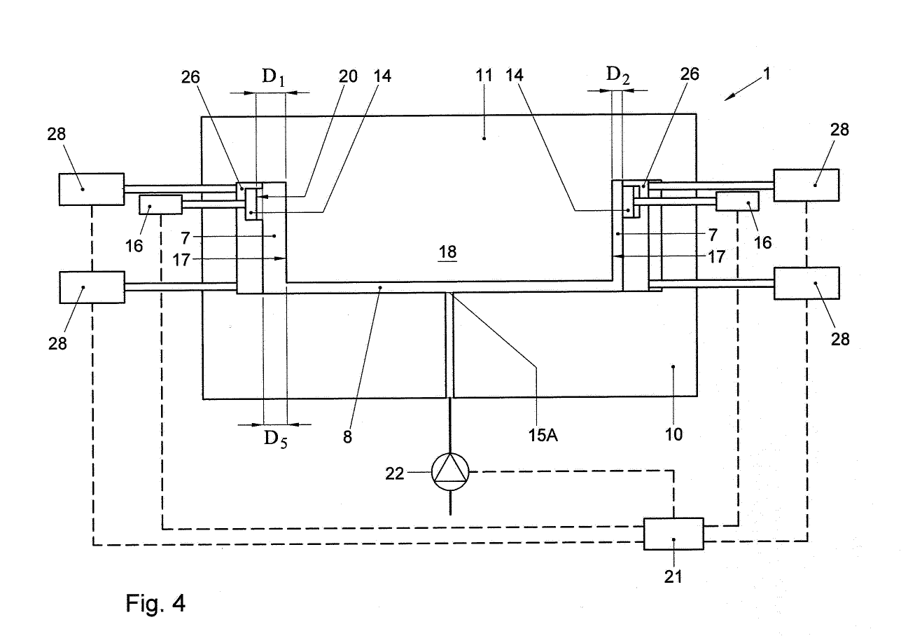

FIG. 4 schematically shows in sectional front view a mold according to the invention, in a third embodiment, with a first movable wall part in a first position (left) and in a second position (right), and with a further movable wall part which at least partly surrounds the first movable wall part;

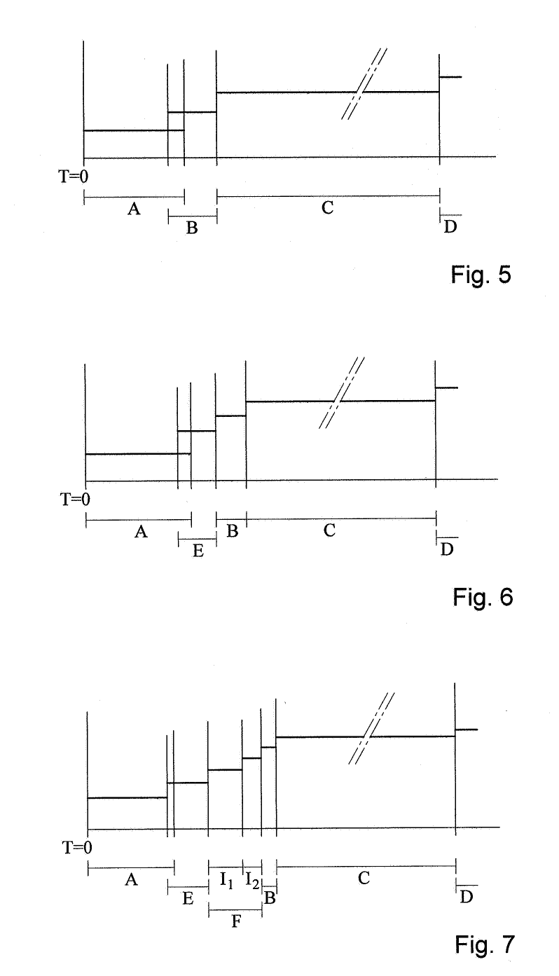

FIG. 5 schematically shows a diagram of the movements of the first wall parts and the injection of plastic when using a mold according to FIG. 1, plotted against time;

FIG. 6 schematically shows a diagram of the movements of the first wall parts, the second wall part and the injection of plastic when using a mold according to FIG. 3, plotted against time;

FIG. 7 schematically shows a diagram of the movements of the first wall parts, the further wall parts and the injection of plastic when using a mold according to FIG. 4, plotted against time;

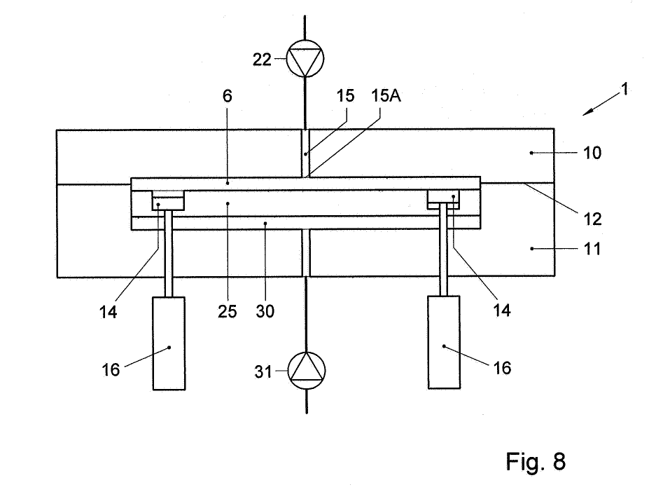

FIG. 8 schematically shows in sectional front view a mold according to the invention, in a fourth embodiment, with a first movable wall part in a first position (left) and in a second position (right), and a second movable wall part in a first position (left) and second position (right) for forming a relatively flat product.

In this description, the same or corresponding parts have the same or corresponding reference numerals. The embodiments shown are shown by way of illustration only and should not be construed as limiting in any way. Many variations thereon are possible.

In this description, exemplary embodiments are given of apparatuses, in particular molds, and methods for manufacturing products, starting from plastic. However, also other materials can be used in such apparatuses, for instance masses based on biopolymers, metals and the like. In this description, frontal surface is understood to mean at least a projected surface at right angles to a respective direction of movement or viewing direction. Movable wall part should herein be understood to mean at least a portion of a wall of a mold cavity that co-forms a part of a product to be formed, which movable wall part may be provided at least, though not exclusively so, on an outer side, an inner side and/or as a core part of/for the mold cavity. Opposite wall part should herein be understood to mean at least a wall part of the mold cavity which, viewed in the direction of movement of the respective movable wall part, is situated opposite the respective wall part. As to projected surface, this can have a same size as the movable wall part or be smaller or larger. The wall parts can have mutually facing sides that are flat or have a profiled, curved, angled or other shape deviating from flat. The or an opposite surface or a part thereof may also be formed by a movable wall part. In the embodiments shown, as drive means for movable wall parts, hydraulic means such as piston-cylinder assemblies are shown. However, other means may be provided, such as, for instance, pneumatic or electric drive means such as a screw spindle motor, a stepping motor, link mechanisms drivable by, for instance, a press which is used for closing the mold or other means obvious to those skilled in the art. The molds shown in the drawing can be used on conventional presses for opening and closing the mold and can be filled using a filling device known per se, for instance a screw feeder, hot runner devices or other injection molding devices known per se. In the embodiments shown, always a single mold is shown, but naturally also multiple (multi cavity) and/or stacked molds (stack molds) may be designed in a comparable manner.

In this description, left, right, top, bottom, front and rear are used for reference to the plane of the drawing, unless indicated otherwise.

In FIGS. 1 and 1A, a mold 1 is shown, in partial section, in front view and top plan view, respectively, along the lines I-I and IA-IA, respectively, with which a product 2 can be formed from plastic. An example of a product 2 is schematically shown in perspective view in FIG. 2. In the example, this product is a crate with a bottom 3, two sidewalls 4 and two end walls 5. In FIG. 1, in the mold 1, a mold cavity 6 is shown, of which two parts 7, forming end walls 5, and part 8, forming the bottom 3, are shown. FIG. 1A shows parts 9, forming the sidewalls 4, and parts 7, forming the end walls. The mold 1 has a first part 10 and a second part 11, which lie on each other in a dividing surface 12, the two parts 10, 11 jointly defining the mold cavity 6, in a manner known per se. With a press not shown or other means, the two mold halves 10, 11 can be pulled apart for demolding products, or be pressed onto each other and/or be held closed against each other during filling and cooling of the products. Naturally, other divisions are also possible.

In the first part 10, a supply device 13 with injection opening 15 is provided, which terminates approximately in the middle of the bottom-forming part 8. In the two sidewall-forming parts 9 and the two end wall-forming parts 7, in each case two movable wall parts 14A, 14B are arranged, each provided with drive means 16, here formed as individual piston-cylinder assemblies, for instance hydraulically driven, for moving the movable wall parts 14A, 14B between a first position and a second position. In the first position, also called retracted position, as shown in FIG. 1 on the left-hand side and in FIG. 1A on the left-hand side and at the top, the respective movable wall part 14A, 14B, in particular a front surface 20 thereof, is situated at a relatively great first distance D₁ from an opposite wall part 17 of the mold cavity, in this case a wall part 17 of a core part 18 on the second mold part 11. The first distance D₁ is here represented in an exaggerated manner. This distance D₁ may for instance be slightly greater than the thickness W₁ of the respective wall 4, 5, at least the width W₁ of the respective forming part 7, 9, measured in the direction of movement F of the respective movable wall part 14A, 14B. As a result, for each movable wall part 14A, 14B in the retracted first position, a relatively large space 19A, 19B has been created.

In FIG. 1 on the right-hand side and in FIG. 1A on the right-hand and bottom side, a comparable movable wall part 14A, 14B is shown, in a forwardly moved second position, where the distance D₂ between the respective movable wall part 14A, 14B and the opposite wall part 17 is smaller than the first distance D₁ and corresponds approximately to the desired wall thickness of the product 2 at the respective position. The space 19A, 19B has thereby been reduced. Each movable wall part 14A, 14B can be moved back and forth between the first and second position by the drive means 16.

As appears from the drawing, at least the frontal surface 20 of each movable wall part 14 is relatively small with respect to the frontal surface of the opposite wall part 17. In FIG. 2, by way of illustration, contours of four movable wall parts 14A, 14B are represented schematically in broken lines on an end wall 5 and a sidewall 4. In this embodiment, the joint frontal surface of the movable wall parts 14 disposed against a wall 4, 5 of the product (in the mold 1) is much smaller than the frontal surface of the opposite wall part 17, for instance less than 50% thereof, more particularly less than 25%. It is particularly advantageous when it is, for instance, approximately 15% or less thereof. Preferably, the width B_{z}, Bₖ of the frontal surface, at least the projected surface thereof, is greater than the height Hₖ, H_{z} thereof, the width being seen in the direction approximately parallel to a longitudinal direction L of an adjacent longitudinal edge-forming part 23. In this longitudinal edge-forming part 23, a free longitudinal edge 24 of the product 2 is formed. In the exemplary embodiment shown, this is the edge around an opening 25 of the container or crate 2. Projected surface should herein be understood to mean at least the projected surface of a normal surface to the direction of movement F of a respective movable wall part 14A, 14B, determined by the frontal surface 20 thereof. The surface of the opposite wall part 17 is determined in a comparable manner by the frontal surface thereof, seen as a normal surface to the direction of movement. By way of illustration, for the product 2 according to FIG. 2, the projected surface of a movable wall part is B_{z}×H_{z} and Bₖ×Hₖ, respectively, while the surface of the respective wall part is B₁×H₁ and B₂×H₁, respectively. Between the injection point 15A and each of the movable wall parts 14A, 14B, a flow path V is defined, one of which is given schematically in FIG. 1. Flow path should herein be understood to mean the path that is traversed by a mass in the mold cavity. In apparatuses according to the invention, the flow paths can be relatively long and narrow. The cross section of the flow paths can for instance be of an order of magnitude that is equal to or less than the minimum dimensions of flow paths for forming a comparable product with conventional injection molding technology. For apparatuses according to the invention, it holds that at least a number of the movable wall parts 14A, 14B are situated at a distance from the injection point that is greater than the distance between the respective movable wall part and the adjacent longitudinal edge-forming space, measured along the relevant shortest flow path between the respective wall part 14 and the injection point 15A. Here, the distances are determined with respect to a middle of the respective wall part 14 and along the shortest flow path. Preferably, then, the dimension of the respective wall part in the direction measured along that shortest flow path is considerably smaller than said distance, preferably less than 15% thereof, more particularly less than 15%.

In the drawing, the dimensions of the apparatuses and products, in particular, for instance, wall thicknesses and distances, are not represented on scale. The distance D between a movable wall part and an opposite wall part is consistently seen as the average distance between a frontal surface of the respective movable wall part and the opposite wall part, while what is regarded as front surface is the surface operatively facing the opposite wall part.

A control device 21 is provided for controlling for instance the drive means 16 and the injection device 13, here represented in simplified form as comprising a pump 22.

During use, a mold 1 according to the invention can be used as follows.

The mold 1 is closed and the movable wall parts 14 are brought in the first position. Next, a fluid mass, for instance plastic heated above a melting temperature, is introduced via an injection opening 15 into the mold cavity 6, into the bottom-forming part 8. From the bottom-forming part 8, the mass is pressed further into the mold cavity, into the further mold cavity, as into parts 9 forming sidewalls, and parts 7, forming end walls, into the spaces 19A, 19B. Preferably, the longitudinal edge-forming parts 23 are thereby largely filled with the mass as well. When substantially all, and preferably all, mass for forming the product has been introduced into the mold cavity 6, the or each movable wall part 14 is moved from the second position into the first position, with a relatively high speed and hence in a relatively short time. Plastic in the spaces 19 is thereby compressed and possibly partly displaced. Next, the mass in the mold cavity 6 is allowed to cool and thereby to solidify, while preferably pressure on the movable wall parts is maintained, in the direction of the opposite wall parts. In this way, shrinkage of the product, in particular near the longitudinal edges, is compensated for, entirely, or substantially entirely, without holding pressure needing to be applied via the injection opening. This is particularly advantageous because moving the relatively small movable wall parts requires relatively little energy and force, so that the drive means can be made of relatively light design and/or can provide for high speeds and accelerations and/or have a relatively low response time. This is especially advantageous because preferably, according to the invention, the control device 21 is set such that the movable wall parts 14A, 14B are moved against and possibly partly into the mass so fast that adiabatic heat development occurs therein. As a result, the temperature of the mass in and/or adjacent the space 19 can be locally raised and hence the viscosity be lowered, so that the flow behavior is positively affected. Moreover, as a result, the stress in the material is reduced and shrinkage can be simply compensated or prevented.

With a mold and method according to the invention, products can be manufactured simply, with relatively little material and/or small wall thicknesses, light and strong, on relatively light machines and moreover with relatively low energy consumption since little heat needs to be added. Further, the advantage is achieved that stresses in the material can be prevented relatively simply, so that, for instance, warp of parts of the product, in particular adjacent the longitudinal edges thereof, is prevented or at least limited.

In FIG. 3, a mold 1 according to the invention is shown, schematically in partial cross section, where to a mold 1 which is comparable in structure to that according to FIG. 1, a second movable wall part 25 has been added, in the bottom-forming part 8. In FIG. 3, on the left-hand side, both the earlier-described movable wall part 14A, now designated as first movable wall part, and the left part of the second movable wall part 25 are represented in a first, retracted position, at a distance D₁ and D₃, respectively, from the opposite wall part 17A, 17B. On the right-hand side, they are shown at the above-mentioned smaller distances D₂ and D₄, respectively, with the movable wall parts 14, 25 in the second, forwardly moved position. The second movable wall part 25 in this embodiment has a frontal (projected) surface that is approximately equal to the surface of the underside of the bottom 3.

In this embodiment, between the frontal surface or the front side 25B of the second movable wall part 25 and the opposite wall part 17B in the first position, a space 19C is formed which is relatively large in proportion to the desired thickness W₂ of the bottom 3. With the second movable wall part 25 in the second position, this space 19C is reduced in that the distance D₄ has been reduced to approximately the desired thickness W₂. Drive means 16B are provided, such as piston-cylinder assemblies, for moving the second wall part 25 back and forth between the first and second position. In this embodiment, the second movable wall part is moved forwards during or directly after injection of a mass, from the first to the second position, so that mass included in the space 19C is at least partly displaced to the remainder of the mold cavity, in particular into the parts 7, 9 forming sidewalls and end walls. Again, this second movable wall part is preferably moved forward so fast that in the mass adiabatic heat development occurs, so that the cooling of the mass, in particular plastic, is slowed or, preferably, the temperature is raised at least in a part of the mass, so that the liquidity is enhanced. As a result, it can be pressed away virtually without the pressure in the space 19 and/or the further mold cavity 6 running up undesirably. As a result, the mold can be held closed in a simple manner and with little force, the plastic can be introduced at a relatively low temperature and pressure and/or particularly thin and long product parts and complicated forms and product parts can be obtained. Living hinges, thinned portions but also thickened portions, acute angles and the like are possible without particular or unwanted stress occurring in the finished product.

Preferably, first the second movable wall part 25 is moved forward and then the or each first movable wall part 14A, 14B.

By way of illustration, an example of a product 2 and a mold 1 is described, which serves for illustration only and should not be construed as limiting in any way.

A crate 2 according to FIG. 2 was formed with a steel mold according to FIG. 3, though only first movable wall parts 14 had been provided on the parts 9 forming the long sidewalls 4, not on the parts 7 forming the end walls 5. The crate had a bottom 2 of a length (B1)×width (B2)×height (H1) of 30×20×15 cm. The wall thickness W1, W2 was approximately 3 mm. For forming, an injector was used having a dosing path of 200 mm and an injection speed of 80 mm/s. The injection pressure was 1600-1700 bar and the closing force of the press was 400 tons. The screw diameter of the injector was 82 mm, the temperature of the plastic (PP) at injection was 250 degrees and the injection time was 2.5 seconds. The second movable wall part 25 had a surface of approximately 60,000 mm², while each of the first movable wall parts 14A, 14B had a frontal surface of approximately 2400 mm² (60×40 mm). The (hydraulic) pressure exerted by the drive means on the first movable wall parts towards and in particular in the second position was 150 bar. The distance that was traveled by the movable wall parts 14, 25 between the first and the second position was 5 mm. That distance took the second movable wall part 25 approximately 1.5 sec, each first movable wall part 14 approximately 1 sec. The distance between the injection point 15A and the first movable wall part 14A, measured along the shortest flow path V, was approximately 230 mm (measured from the injection point 15A to the middle of the respective first wall part 14) while the first movable wall parts were situated at approximately 30 mm from the adjacent longitudinal edge (the distance measured from the middle of the respective movable wall part, which meant that the longitudinal edge of the movable wall part that was closest to the longitudinal edge 24B of the crate was at approximately 10 mm distance therefrom.

With the screw injector, the plastic was introduced into the mold cavity, with the movable wall parts in the first position. At a residual dosing path of 75 mm (that is, when the screw had already traversed 125 mm of the dosing path), the second movable wall part was set in motion and moved to the second position. After 195 mm of the dosing path had been traversed by the screw, next, the first movable wall parts 14 were set in motion and moved to the second position.

After the mold cavity had been filled completely and the movable wall parts had been brought in the second position, the pressure of approximately 150 bar was maintained on the movable wall parts, during cooling of the product in the mold, so that shrinkage as a result of at least the cooling was compensated by at least the first movable wall parts. In this way, upon taking out the crate, a crate was obtained with taut sidewalls and end walls and especially the desired straight longitudinal edges, which moreover remained flat and straight, respectively. The cooling time was approximately 20 sec, the total cycle time approximately 43 sec. That is considerably shorter than in conventional injection molding of a comparable crate.

It will be clear that for different product shapes and materials, other molds with other movable wall parts, other injection means and other plastics can be used and that the speeds of movement, positions, numbers and shapes of the movable wall part can or need to be adjusted accordingly. Optimization of these design and use parameters is within reach of the skilled person, starting from this invention.

FIG. 4 shows a further variant of a mold according to the invention, broadly corresponding to that according to FIG. 1, though for at least one pair of walls and preferably all walls, in addition to the first movable wall parts 14, a further movable wall part 26 is provided, with preferably its own drive means 28. These can again be brought in a first position, as shown in FIG. 4 on the left-hand side, and in a second position, shown on the right-hand side. In the first position, the front side of the further movable wall parts 26 is situated at a distance D₅ from the opposite wall part 17, which distance D₅ is for instance slightly smaller than the distance D₁ between the first movable wall part 14 in the first position and that further wall part 17. In the second position, the front sides of the or each first movable wall part 14 and the respective further movable wall part 26 are approximately flush, at a distance D₂ from the opposite wall part, which is approximately equal to the desired wall thickness W₁.

In this embodiment, the control means 21 are arranged such that during and/or after injection of the mass such as plastic into the mold cavity 6, with the movable wall parts 14, 26 having been brought in the first position or being brought in the first position by the plastic, first the further movable wall parts 26 are moved away from the first position, to the second position, and then the first movable wall parts 14 are set into motion from the first position and are moved to the second position. The start of the movement of the first movable wall parts can occur during the movement of the further movable wall parts 26 or, preferably, directly after that. The or each further movable wall part 26 is then in a first phase I₁ moved relatively slowly, over a first distance, and then accelerated, such that in a second phase I₂ the wall part 26 is driven with a much higher speed against and possibly into the plastic, to the second position. Here, preferably, in the first phase I₁ the liquid plastic mass is kept in motion by the further wall part 26 and moved and displaced approximately parallel to the surface of the wall part, especially in the direction of the longitudinal edge-forming part 23, while in the second phase I₂ adiabatic heat development is generated therein and the plastic is displaced faster and being more liquid. The or each first movable wall part 14 is then preferably moved to the second position so fast that in the earlier-described manner, in the mass between the respective movable wall part 14 and the opposite wall part 17, the adiabatic heat development occurs. Cooling is then slowed and preferably the temperature in at least a part of the mass is raised, in particular to above the melting temperature of the respective plastic at the pressure prevailing in the mold cavity.

In the embodiment shown, the or each first movable wall part 14, together with the further movable wall part 26, covers approximately a surface that is equal to that of the opposite wall part, for instance the end wall 5 or the sidewall 4 of the crate 2. Preferably, the or each first movable wall part 14 is set into motion when the respective space 7, 9 between the further movable wall part 26 and the opposite wall part 17 is largely filled with plastic, for instance for approximately 90% or even 95%. Incidentally, setting into motion of the or each first movable wall part 14 in this embodiment should be understood to mean at least, though not exclusively so, motion relative to the respective further movable wall part 26.

In illustration, an embodiment will be described which should not be construed as limiting in any way.

A crate 2 according to FIG. 2 was formed with a steel mold according to FIG. 4. The crate had a bottom 2 of a length (B1)×width (B2)×height (H1) of 30×20×15 cm. The wall thickness W1, W2 was approximately 3 mm. For forming, a screw injector was used having a dosing path of 200 mm and an injection speed of 80 mm/s. The injection pressure was 1600-1700 bar and the closing force of the press was 400 tons. The screw diameter of the injector was 82 mm, the temperature of the plastic (PP) at injection was 250 degrees and the injection time was 2.5 seconds. The further movable wall part 26 had a surface of approximately 25,000 mm², while each of the first movable wall parts 14A, 14B had a frontal surface of approximately 2400 mm² (60×40 mm). The (hydraulic) pressure exerted by the drive means on the first movable wall parts towards and in particular in the second position was 150 bar. The distance that was traveled by the movable wall parts 14, 25 between the first and the second position was 5 mm.

Each further movable wall part 26 was moved in the first phase I₁ over a distance of approximately 3 mm and took approximately 1.2 sec to travel that distance. Next, in the second phase I₂ it was moved to the second position in approximately 0.3 sec. Each first movable wall part 14 was brought from the first to the second position in approximately 1 sec, with an approximately constant speed. The distance between the injection point 15A and the first movable wall parts 14A, measured along the shortest flow path V, was approximately 240 mm (measured from the injection point 15A to the middle of the respective first wall part 14) while the first movable wall parts were situated at approximately 30 mm from the nearby longitudinal edge, the distance being measured from the middle of the respective movable wall part, which meant that the longitudinal edge of the movable wall part that was closest to the longitudinal edge 24B of the crate was at approximately 10 mm distance therefrom.

With the screw injector, the plastic was introduced into the mold cavity, with the movable wall parts in the first position. At a residual dosing path of approximately 80 mm (that is, when the screw had already traversed 120 mm of the dosing path), the further movable wall part was set in motion and moved to the second position. After 190 mm of the dosing path had been traversed by the screw, next, the first movable wall parts 14 were set in motion and moved to the second position.

After the mold cavity had been filled completely and the movable wall parts had been brought in the second position, the pressure of approximately 150 bar was maintained on the movable wall parts, during cooling of the product in the mold, so that shrinkage as a result of at least the cooling was compensated by at least the first movable wall parts. In this way, upon taking out the crate, a crate was obtained with taut sidewalls and end walls and especially the desired straight longitudinal edges, which moreover remained flat and straight, respectively. The cycle time was again approximately 43 sec, of which approximately 20 sec cooling time.

With such an embodiment, the plastic can be moved in a relatively controlled manner and with relatively little pressure for the purpose of filling substantially the entire mold cavity, while the eventual complete filling of the mold cavity in the desired, product-forming position, can be achieved rapidly and with little pressure on the closing surfaces of the mold.

FIG. 8 shows a mold 1 according to the invention with which relatively flat products can be formed. It shows a series of first movable wall parts 14, at a relatively large distance from an injection point 15A and a relatively small distance from the adjacent longitudinal edge 23. In this embodiment, a second movable wall part 25 is provided which has a leading surface that is approximately equal to the projected surface of the product to be formed, for instance a file, folder, cover, pallet or other relatively large, flat product, in proportion to the wall thickness W. The second movable wall part 25 is here designed as a piston in a chamber 30 into which, using a pump device 31, a hydraulic fluid can be introduced, for moving the second movable wall part 25 between a first and second position that are comparable to those as shown in, for instance, FIG. 3. The first movable wall parts 14, using drive means 16, are likewise movable between a first and second position, relative to the second movable wall part 25. For this mold, also, it holds that the second and/or the first movable wall parts can be moved with such a speed that adiabatic heat development occurs in at least a part of the plastic. As a result, the product 2 is kept flat and taut, at relatively low injection pressures and injection temperatures, at a low closing force and holding pressures, and moreover particularly thin and large-surface products can be formed.

Because in molds according to the invention the first movable wall parts are relatively small with respect to the dimensions of the products to be formed, relatively little energy is needed for setting and keeping them in motion, while moreover the drive means for moving and holding them in the second position can be made relatively small.

FIGS. 5-7 schematically show diagrams for three molds, plotting the different phases in the cycle against time.

In FIG. 5, a diagram is shown for a mold according to FIG. 1. It shows an injection phase A, a movement phase B for the first movable wall part 14, a cooling phase C and a take-out phase D. It is clear to see that the injection phase A and the movement phase B overlap to some extent.

In FIG. 6, a diagram is shown for a mold according to FIG. 3. It shows an injection phase A, a movement phase B for the first movable wall part 14, a cooling phase C and a take-out phase D, comparably to FIG. 5. Additionally shown, however, is a movement phase E for moving the second movable wall part 25, which starts during the injection phase A and ends at the beginning or right after the start of the movement phase B for the first movable wall parts 14.

In FIG. 7, a diagram is shown for a mold according to FIG. 4, where, however, in addition a second movable wall part 25 is provided (not shown in FIG. 4) as shown and described in FIG. 3. In this diagram, an injection phase A, a movement phase B for the first movable wall part 14, a cooling phase C and a take-out phase D are shown, comparably to FIG. 5, as well as a movement phase E according to FIG. 6. Moreover, a further movement phase F is shown for movement of the further movable wall parts 26. This phase F is subdivided into the first phase I₁ and the second phase I₂, as described earlier.

The invention is not limited in any way to the exemplary embodiments shown in the description and drawings. Many variations thereon are possible within the scope of the invention outlined by the claims.

For instance, other types of products may be formed and the molds may be designed differently, for instance of multi-cavity, stack mold or other design. Hot runners and cold runners may be used. Different parts of the embodiments shown can be combined and varied within the invention. Moreover, wall parts that are shown as fixed here may also be movable, or kinematic inversions may be applied. Injection points may be provided at other positions and moreover in a mold cavity multiple injection points may be provided for one product. In such an embodiment, the distance to the injection point is understood to mean at least, though not exclusively so, the distance to a central point between the injection points. As indicated, for each product and mold design, and depending inter alia on the shapes, number and position of the moving parts and the plastic applied, the movement pattern for the various parts will be determined by simple tests and simulations. More or fewer movable wall parts may be used, with larger or smaller surfaces, which moreover may be curved, angled and/or irregularly shaped and, for instance, may also extend partly over a longitudinal edge or around an opening, hollow, thickening or deepened portion. The or each injection point may extend near or opposite a center of the second movable wall part but may also be provided near a contour thereof, or a combination of both may be used. When using mold cavities that form walls that are at an angle with each other, it is advantageous when the movement of the first movable wall parts and/or the further movable wall parts is initiated when at least a part of the mass has passed such angle, so that a flowing movement is maintained. The drive means may be designed differently and possibly be combined for different movable wall parts and/or opening and closing the mold.

These and many other variations are understood to fall within the framework of the invention outlined by the claims.

1. A method for manufacturing products using a mold having at least one mold cavity with at least one injection point and at least one flow path which extends from said at least one injection point in the direction of a longitudinal edge-forming part of the mold cavity situated at a relatively large distance from said at least one injection point, in which longitudinal edge-forming part a longitudinal edge of said product is formed, which mold cavity has at least one first movable wall part which is situated in and/or near said longitudinal edge-forming part, wherein said first movable wall part has been or is brought in a first position, at a relatively large distance from an opposite wall part, wherein a mass is introduced under pressure into the mold cavity, such that the mold cavity is filled with said mass and mass extends between the at least one first movable wall part and the opposite first wall part, and fills the mold cavity at least in and/or near said longitudinal edge-forming part, after which said at least one first movable wall part is moved in the direction of said opposite first wall part, such that said mass between said at least one first movable wall part and the opposite first wall part is pressurized and possibly partly displaced.

2. A method according to claim 1, wherein said first movable wall part is moved in the direction of the opposite first wall part so fast that in the mass therebetween adiabatic heat development occurs, such that the viscosity thereof is reduced.

3. A method according to claim 1, wherein said at least one first movable wall part which is moved in the direction of said opposite wall part has a frontal surface that is small in proportion to the distance between the at least one injection point and said movable wall part, measured along said flow path, wherein the respective wall part preferably has a maximum dimension that is less than half of said distance, more particularly less than one-third thereof.

4. A method according to claim 1, wherein the mold is closed in a closing direction and at least two first movable wall parts are moved, preferably with a joint frontal surface that is smaller than the frontal surface of the mold cavity, viewed in said closing direction of the mold.

5. A method according to claim 1, wherein at least one second movable wall part in or of the mold cavity is provided, which extends at least partly between said at least one injection point and said at least one first movable wall part, which at least one second movable wall part is brought in a first position, at a relatively large, first distance from an opposite second wall part of the mold cavity and during or after introduction of at least a part of the mass is moved to a second position, at a second distance from said opposite second wall part of the mold cavity, which second distance is smaller than the first distance, wherein the movement of said at least one second movable wall part is initiated before said first movable wall part is moved.

6. A method according to claim 5, wherein said at least one second movable wall part is brought in the second position before said at least one movable wall part is moved from the respective first position.

7. A method according to claim 5, wherein said at least one second movable wall part is moved to the respective second position with such speed that in mass situated therebetween adiabatic heat development occurs and moreover a part of said mass is displaced from between said at least one second movable wall part and said opposite second wall part.

8. A method for manufacturing products using a mold having at least one mold cavity, in particular according to claim 1, which mold cavity has at least one movable wall part, wherein a mass is introduced under pressure into the mold cavity, between the at least one movable wall part and an opposite wall part, wherein said at least one movable wall part has been or is brought in a first position, next during a first phase is moved with a first average speed over a first distance in the direction of said opposite wall part and then in a second phase is moved with a second average speed over a second distance in the direction of said opposite wall part, such that in at least the second phase, adiabatic heat development occurs in the mass situated in between.

9. A method according to claim 8, wherein the first average speed is lower than the second average speed.

10. A method according to claim 8, wherein during at least a part of the first phase, said mass is introduced into the mold cavity, in particular such that during said part of the first phase said mass is moved between the at least one movable wall part and said opposite wall part under the influence of the pressure at introduction of the mass into the mold cavity.

11. A method according to claim 8, wherein in the first phase said movable wall part is moved such that mass included between said movable wall part and said opposite wall part is moved in at least one direction approximately parallel to a surface of the movable wall part facing the mass, thereby displacing the plastic, while in the second phase the plastic is pressurized between said movable wall part and said opposite wall part, such that adiabatic heat development occurs therein, so that the viscosity of the respective mass is lowered.

12. A method according to claim 8, wherein the second phase is initiated when the space between said at least one movable wall part and the opposite wall part is substantially completely filled with said mass.

13. A method according to claim 8, wherein the second phase is initiated when the space between said movable wall part and the opposite wall part is filled with said mass for at least 90%, more particularly for at least 95%.

14. A method according to claim 8, wherein the at least one movable wall part is provided with a contour and the mass is introduced into the space between said movable wall part and the opposite wall part at a point remote from said contour.

15. A method according to claim 8, wherein the at least one movable wall part is provided with a contour and the mass is introduced into the space between said movable wall part and the opposite wall part at a point near said contour.

16. A method according to claim 8, wherein the plastic is introduced from at least one injection point into the mold cavity and thence follows a flow path to the space between said movable wall part and the opposite wall part, which flow path between said at least one injection point and said space includes an angle of between 10 and 170 degrees, wherein the second phase is initiated after said mass has at least partly passed said profiling and preferably also the first phase is not initiated until the mass has at least partly passed said angle in the flow path.

17. A method according to claim 1, wherein the average speed in the first phase is at most half of the average speed in the second phase, more particularly at most one-third and preferably at most one-fourth.

18. An apparatus for manufacturing products, comprising a mold having at least one mold cavity which has at least one first movable wall part, wherein drive means are provided for driving the at least one first movable wall part, which mold cavity comprises at least one injection point and defines at least one flow path between said injection point and a longitudinal edge-forming part of said mold cavity, remote from said injection point, wherein said at least one first movable wall part is situated closer to said longitudinal edge-forming part than to said injection point, measured along said flow path.

19. An apparatus according to claim 18, wherein said at least one first movable wall part has a longitudinal edge facing the injection point which is situated further from said injection point than from said nearby longitudinal edge-forming part, measured along said flow path.

20. An apparatus according to claim 18, wherein said at least one first movable wall part has a middle which is situated further from said injection point than from said nearby longitudinal edge-forming part, measured along said flow path.

21. An apparatus according to claim 18, wherein said opposite wall part has a frontal surface, viewed in the direction of movement of said at least one movable wall part, wherein said movable wall part or said movable wall parts opposite said wall part jointly have a frontal surface, viewed in the direction of movement of the respective said at least one movable wall part, which frontal surface or joint frontal surface is smaller than that of said opposite wall part, in particular at most approximately 50% of said frontal surface of the opposite wall part, in particular at most 25% of that frontal surface.

22. An apparatus according to claim 18, wherein the or each movable wall part has a longitudinal edge that faces said longitudinal edge-forming part of the mold cavity and is closer to said longitudinal edge-forming part than the length of said movable wall part measured in the direction of the flow path, more particularly at a distance of at most 50% of said length, more particularly at most 25%.

23. An apparatus according to claim 18, wherein a second movable wall part is provided which extends at least partly between said at least one injection point and said at least one movable wall part, which second movable wall part is preferably around or opposite said at least one injection point, wherein control means are provided for moving said second wall part during or after injection of a mass of plastic into the mold cavity, preferably so fast that adiabatic heat development occurs in said mass, between said second movable wall part and an opposite second wall part of the mold cavity, and for moving the or each movable wall part near said longitudinal edge-forming part after said mass of plastic has been introduced into the mold cavity and fills the mold cavity at least substantially entirely and preferably entirely.

24. An apparatus for manufacturing products, in particular according to claim 18, comprising a mold having at least one mold cavity and at least one injection point, which mold cavity has at least one primary movable wall part, with primary drive means being provided for driving the at least one primary movable wall part, which primary drive means are arranged for moving said at least one primary movable wall part in a first phase with a first average speed and moving said primary movable wall part in a second phase over a second distance with a second average speed, the second average speed being higher than the first and being sufficient to generate adiabatic heat development in a mass between said at least one primary movable wall part and an opposite wall part.

25. An apparatus according to claim 24, wherein at least one further movable wall part is provided, next to which or around which said primary movable wall part extends, wherein said drive means are provided for driving said movable wall part and further drive means are provided for driving said at least one second movable wall part, wherein control means are provided for first driving the or each said primary movable wall part into the second position and then driving the or each further movable wall part from a first position situated relatively far from said opposite wall part to a second position situated closer thereto.

26. An apparatus according to claim 24, wherein a second movable wall part is provided which extends at least partly between said at least one injection point and said at least one movable wall part, which second movable wall part is preferably situated around or opposite said at least one injection point, wherein control means are provided for moving said second wall part during or after injection of a mass of plastic into the mold cavity, preferably so fast that adiabatic heat development occurs in said mass, between said second movable wall part and an opposite second wall part of the mold cavity, and for moving the or each movable wall part adjacent said longitudinal edge-forming part after said mass of plastic has been introduced into the mold cavity and fills the mold cavity at least substantially entirely and preferably completely.
